(19) United States
(12) Patent Application Publication
(10) Pub. No.: US 2008/0170648 A1
(43) Pub. Date: Jul. 17, 2008

(54) METHOD, WIRELESS DEVICE AND WIRELESS COMMUNICATION SYSTEM FOR REALIZING INFORMATION TRANSFER BETWEEN WIRELESS DEVICES

(75) Inventor: Xuyong Wu, Shenzhen (CN)

Correspondence Address: DARBY & DARBY P.C., P.O. BOX 770, Church Street Station, New York, NY, 10008-0770, US

(73) Assignee: HUAWEI TECHNOLOGIES CO., LTD., Shenzhen (CN)

(21) Appl. No.: 12/042,997

(22) Filed: Mar. 5, 2008

Related U.S. Application Data
(63) Continuation of application No. PCT/CN2006/002282, filed on Sep. 5, 2006.

(30) Foreign Application Priority Data
Sep. 5, 2005 (CN) 200510098755.0

(51) Int. Cl. H04L 7/00

(52) U.S. Cl. 375/354

(57) ABSTRACT

A method, wireless device and wireless communication system for implementing information transfer between wireless devices includes a wireless device of the sending party that carries information with a small amount of data (such as address information in an energy keying pulse (energy pulse) sequence) and sends the information to a receiving party in a periodic time interval. A wireless device of the receiving party obtains the information by monitoring and identifying the energy keying pulse sequence. Some time periods may be selected and used to send some information with a small amount of data to other wireless devices in the coverage area via energy keying pulses, so that the information may be correctly received.

### CROSS REFERENCE TO RELATED APPLICATIONS

This application is a Continuation of PCT/CN2006/002282 filed Sep. 5, 2006, and claims the benefit of Chinese Patent Application No. 200510098755.0 filed on Sep. 5, 2005, both of which are incorporated by reference in their entireties herein. The PCT application published in Chinese as WO2007/028327 A1.

### TECHNICAL FIELD

The present invention relates to the technical field of wireless communications, in particular, to a method, wireless device and wireless communication system for implementing information transfer between wireless devices.

### BACKGROUND OF THE INVENTION

With the rapid development of Broadband Wireless Access (BWA) technology, a technology for developing broadband metropolitan area access using wireless resources finds a strong vitality and a broad market.

Wireless spectrum resources are very precious. In some areas not well planned or some License-Exempt frequency bands, a plurality of base stations may run on the same channel. As a result, the signals of different base stations may interfere with each other. Therefore, for coordination and coexistence of each base station device under the same frequency band, especially, for the coexistence of each base station device under License-Exempt frequency bands, some coexistence mechanisms among base station devices need to be established.

In a coexistence system with the coexistence mechanism, it is usually required that the transceiving synchronization should be guaranteed among different base stations. Therefore, it may be ensured that the transceiving interference among stations near to each other is avoided. For example, for base stations BS1 and BS2 in FIG. 1, if BS2 is receiving signals when BS1 is sending signals, severe interference will be introduced to the receiving of signals from subordinate terminals of BS2.

The base station has two states: a normal working state and a starting initialization state. The initialization process of a newly started base station near several base stations in the normal working state will now be described below. All coexistence base stations are connected to a core network via a wired path, and may communicate with each other via a wire.

As shown in FIG. 2, there is a plurality of base stations near to starting base station SBS1, including WBS1, WBS2, WBS3 and WBS4. WBS1, WBS2, WBS3 are adjacent stations of SBS1. The adjacent station refers to base stations having common coverage areas for terminals. As shown in FIG. 2, terminals A and B exist in the common coverage area of WBS1 and SBS1, terminal C exists in the common coverage area of WBS2 and SBS1, and terminal D exists in the common coverage area of WBS3 and SBS1. Therefore, it may be determined that WBS1, WBS2, WBS3 are adjacent stations of SBS1.

To ensure that the negotiation may be performed among adjacent stations so as to implement a coexistence mechanism, for a newly established base station, the message interaction needs to be established between adjacent stations when the newly established base station starts. However, the newly established base station cannot contact with the adjacent base stations via an air interface directly. Therefore, the adjacent stations may only perform the message interaction via the wired network, so that the base station needs to know the contact information of the adjacent stations, such as an IP address.

To ensure that the base station may obtain the contact information of the adjacent stations, a process shown in FIG. 3 is provided in the prior art. The newly started base station needs to broadcast the IP address or other equivalent contact address to all the terminals in the coverage area. For example, SBS1 first sends the IP address to terminal SS_A, and terminal SS_A forwards the obtained address information to the base station to which terminal SS_A pertains originally, such as WBS1, and subsequently, the working base station to which terminal SS_A originally pertains finds the newly started base station via a wired network and performs the corresponding message interaction.

To implement the mechanism shown in FIG. 3, a signal sent by the starting base station and carrying the contact address (IP address) should be received and decoded correctly by the terminal. At present, a plurality of modulation-demodulation physical layers are used, including Single Carrier (SCa), Orthogonal Frequency Division Multiplexing (OFDM) and Orthogonal Frequency Division Multiple Access (OFDMA) and so on.

It can be seen that a terminal employing a technology different from the physical layer technology for the newly added base station cannot correctly receive the physical layer information sent from the newly added base station. Therefore, the IP address of the new base station may not be reported correctly, such that connectivity over wired network can not be established between the new and old base stations. Moreover, even if the newly added base station employs the same physical layer technology as that of the terminal, a correct demodulation may only be implemented when the sending and the receiving parties are synchronized strictly. In order to synchronize correctly, a lot of overhead needs to be added, such as a preamble. Additionally, the frequency bandwidth and the frequency point of the sending and the receiving parties also need to be aligned; otherwise, the information interaction can not be accomplished.

Therefore, in the prior art, it is impossible to ensure that a newly added adjacent base station can easily interact with an existing base station in the process shown in FIG. 3.

### SUMMARY OF THE INVENTION

An object of the present invention is to provide a method, a wireless device and a wireless communication system for implementing an information transfer between wireless devices. Therefore, a reliable transfer for information with small amount of data may be implemented between a wireless device employing a heterogeneous physical layer technology, a wireless device without symbol-level synchronization, or a device whose frequency bands are not aligned but have an overlapped part.

The object of the present invention is accomplished through the following technical solutions:

A method for implementing an information transfer between wireless devices includes sending, by a wireless device of a sending party, information to be sent, to a receiving party in an energy keying pulse sequence in a specific periodic time interval, and obtaining, by a wireless device of the receiving party, the information sent from the wireless device of the sending party by monitoring and identifying the energy keying pulse sequence in the specific periodic time interval.

The specific periodic time interval includes a time interval before transmit-receive transition gap of a Time Division Duplexing, TDD, frame structure, or a time interval before a starting position of a Frequency Division Duplexing (FDD), frame.

The information to be sent includes, but is not necessarily limited to:

at least one of address information and sector number information of the wireless device.

Sending the information to be sent to the receiving party includes

determining a structure and a sending time of an energy keying pulse sequence, and
performing an energy keying pulse mode mapping on the information to be sent according to the structure of the energy keying pulse sequence, and sending the energy keying pulse sequence at a determined sending timing slot.

The energy keying pulse sequence includes at least one of a Start Of Sequence, information payload, an End Of Sequence, checking information, a message sequence type and a message sequence length.

The structure of the energy keying pulse sequence includes a combination of symbols 0 and 1 employed by a Start Of Sequence and an End of Sequence, different from the data information payload, or a symbol, employed by the Start Of Sequence and the End of Sequence, different from the data information payload.

The energy symbol includes a combination of different energy levels on timing interval.

Obtaining the information sent from the wireless device of the sending party includes:

monitoring, by the wireless device of the receiving party, a signal strength at an air interface, and resolving information sent from the wireless device of the sending party according to signal strength received in different time interval and a threshold of the received signal strength with respect to a determination time.

The predetermined threshold of the received signal strength with respect to the determination time is determined according to a mode of an energy pulse symbol sent by the sending party, and each threshold is determined according to a strength range of signals received in a specific time interval.

Obtaining the information sent from the wireless device of the sending party also includes within combinations of periodic time intervals, determining to receive complete information according to the Start of Sequence and the End of Sequence of an energy keying pulse sequence, and resolving a information value sent by the sending party from the complete information.

Obtaining the information sent from the wireless device of the sending party further includes checking the information resolved from the complete information, and if the information is correct, obtaining the information value sent by the sending party from the payload information contained in the information.

A device between the wireless device of the sending party and the wireless device of the receiving party includes at least one of a device employing a heterogeneous physical layer technology, a device without a symbol-level synchronization, and a device whose frequency bands are not aligned but have an overlapped part.

The present invention further provides a wireless device, including a wireless device information sending apparatus, and the wireless device information sending apparatus includes a transmission sequence structure and timing processing unit, an energy keying pulse mode mapping unit and an energy control sending unit. The transmission sequence structure and timing processing unit is adapted to perform an energy keying pulse sequence structure adaptation on information to be sent, and determine the time when to send the information. The energy keying pulse mode mapping unit is adapted to map the information to be sent into an energy keying pulse symbol sequence according to a predetermined energy keying pulse mode, and the energy control sending unit is adapted to send the energy keying pulse symbol sequence carrying the information to be sent with an energy corresponding to the energy keying pulse mode at a determined time.

The present invention further includes a wireless device having a wireless device information receiving apparatus, and the wireless device information receiving apparatus includes an energy detection receiving unit, an energy keying mode determining unit and a receiving sequence structure and timing processing unit. The energy detection receiving unit is adapted to monitor a received signal strength at an air interface, and determine quantized indication information of the received signal strength. The energy keying pulse mode determining unit is adapted to judge the indication information of the received signal strength according to a predetermined threshold of the received signal strength and optionally according to a determination time corresponding to the strength threshold, and obtain symbol information sent by the sending party. The transmission sequence structure and timing processing unit is adapted to collect complete sequence information according to a predetermined timing position of a time interval, a Start Of Sequence and an End Of Sequence, and extract information data carried in the sequence from the sending party.

The present invention further provides a wireless communication system, including a wireless device of a sending party and a wireless device of a receiving party, and a wireless device information sending apparatus is configured in the wireless device of the sending party, and a wireless device information receiving apparatus is configured in the wireless device of the receiving party; the wireless device of the sending party sends information to be sent in an energy keying pulse sequence within a specific periodic time interval via the wireless device information sending apparatus; and the wireless device of the receiving party obtains the information by monitoring and identifying the energy keying pulse sequence within the specific periodic time interval via the wireless device information receiving apparatus.

According to the present invention, some time periods may be used to send some information with a small amount of data to other wireless devices in the coverage area via energy keying pulses, and the information may be received correctly. Moreover, the present invention may not add significant cost and complexity to the device. Therefore, according to the present invention, intercommunication of a small amount information between devices using heterogeneous modulation technology may be implemented, and advantages, such as a high compatibility, a simple implementation and a low implementation cost, may be provided.

Additionally, according to the present invention, a periodic time interval for sending an energy keying pulse sequence is defined from a position of the transmit-receive transition gap of a TDD frame structure or from a time position before the Start of Frame of an FDD frame. As a result, it may be avoided that the preamble must be added because the original physical burst is interrupted due to adding the time period, so that no unnecessary overhead needs to be added for the time period.

### BRIEF DESCRIPTION OF THE DRAWINGS

The invention will be more readily apparent from the Detailed Description of the Invention, which proceeds with reference to the drawings, in which:

FIG. 1 is a schematic diagram showing a networking of a conventional wireless network;

FIG. 2 is a schematic diagram showing a correlation between adjacent base stations in the method of FIG. 1;

FIG. 3 is a schematic diagram showing an initialization interaction process of an SBS in the network of FIG. 1;

FIG. 4 is a schematic diagram showing that the frequency bands between transceiving devices are not aligned but have an overlapped part;

FIG. 5 is another schematic diagram showing that the frequency bands between transceiving devices are not aligned but have an overlapped part;

FIG. 6 is another schematic diagram showing that the frequency bands between transceiving devices are not aligned but have an overlapped part;

FIG. 7 is another schematic diagram showing that the frequency bands between transceiving devices are not aligned but have an overlapped part;

FIG. 8 is a schematic diagram showing the specific structure of the system according to the present invention;

FIG. 9a is a schematic diagram showing the structure of the sending apparatus according to the present invention;

FIG. 9b is another schematic diagram showing the structure of the receiving apparatus according to the present invention;

FIG. 10 is a schematic diagram showing the structure of the information sequence sent based on Time Division Duplexing (TDD);

FIG. 11 is a schematic diagram showing the structure of the sequence carrying coexistence information;

FIG. 12 is a schematic diagram showing the structure of the information sequence sent based on Frequency Division Duplexing (FDD);

FIG. 13 is a schematic diagram of an energy symbol;

FIG. 14 is another schematic diagram of an energy symbol;

FIG. 15 is a schematic diagram showing the mode determination of FIG. 13; and

FIG. 16 is a schematic diagram showing the mode determination of FIG. 14.

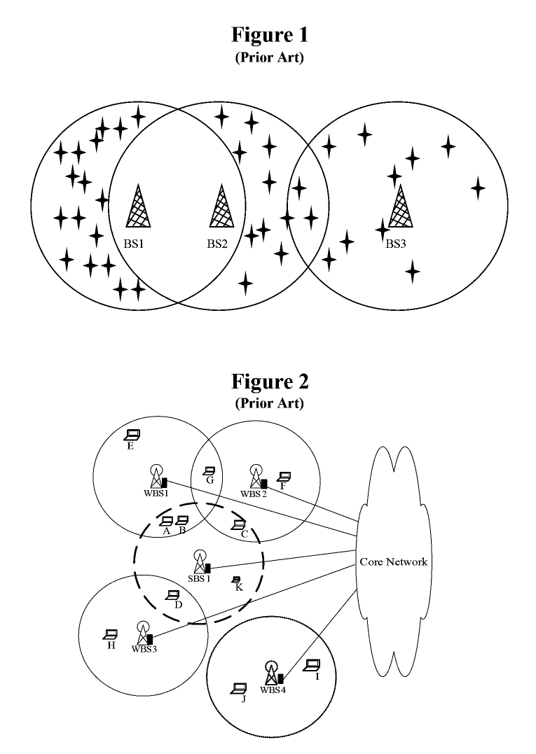

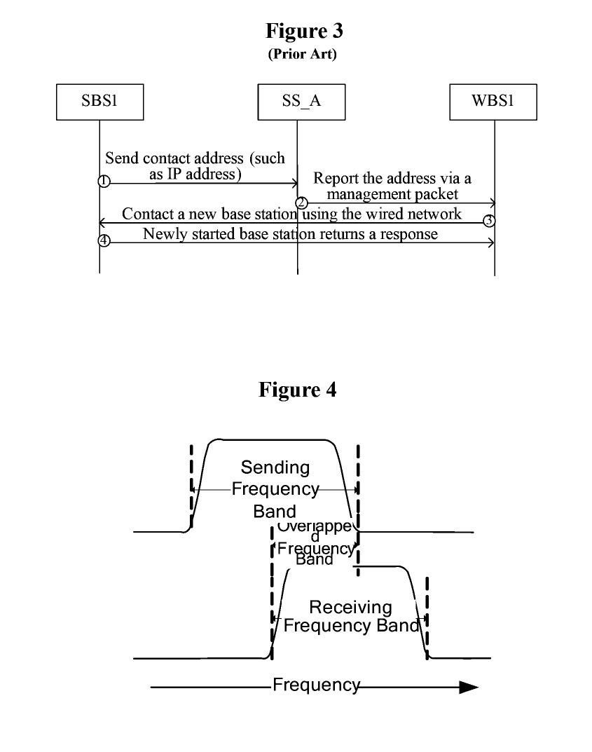

### DETAILED DESCRIPTION OF THE INVENTION

According to the present invention, sending and receiving information with a small amount of data, such as broadcasting an IP address of a newly started base station, may be implemented during the process of finding adjacent stations when a coexistence base station starts, without changing the original physical layer technologies of the base station and the terminal.

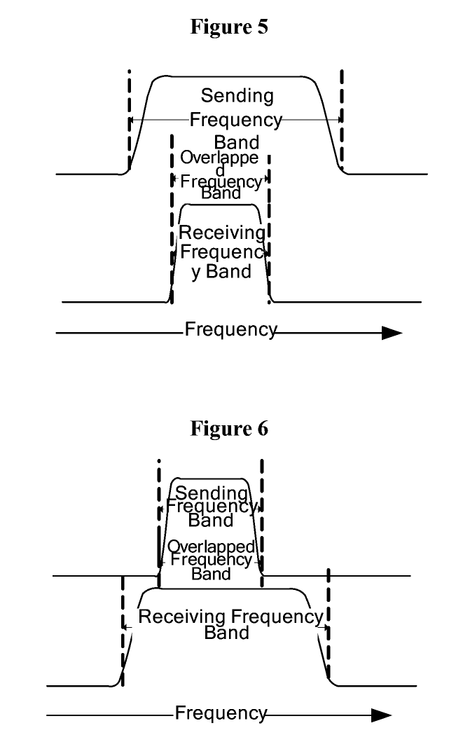

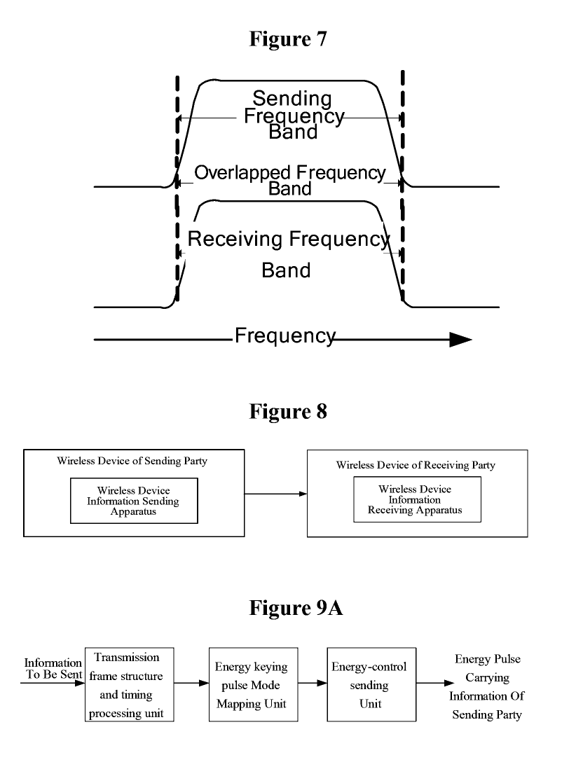

The present invention mainly satisfies requirements for reliably transferring information with small amount of data between devices employing heterogeneous physical layer technologies, or between devices without the symbol-level synchronization, or between devices whose frequency bands are not aligned but have an overlapped part. The heterogeneous physical layer technology may include Single Carrier (SCa), Orthogonal Frequency Division Multiplexing (OFDM) and so on. For example, if one device employs the SCa technology and the other device employs the OFDM technology, the devices are referred to as the devices employing the heterogeneous physical layer technologies. A device without symbol-level synchronization may be a device not performing the synchronization process of the preamble/the training code. The case in which the frequency bands are not aligned but have an overlapped part is shown in FIG. 4 to FIG. 7, and several possible situations for devices whose frequency bands are not aligned but have an overlapped part are given.

The core concept of the present invention lies in that information with small amount of data to be sent is carried via an energy keying pulse timing slot in a determined time interval (i.e. a specific periodic time interval) and sent to a destination device which is ready to receive the information. The corresponding wireless device may receive the information with small amount of data from the wireless device of the sending party, and the information with small amount of data may include the IP address information and the sector number information of the newly added base station and so on.

The method and system of the present invention are now illustrated in detail in conjunction with the drawings.

First of all, the system of the present invention is illustrated in conjunction with the drawings. As shown in FIG. 8, the system includes a wireless device of the sending party and a wireless device of the receiving party, and a wireless device information sending apparatus is configured in the wireless device of the sending party, and a wireless device information receiving apparatus is configured in the wireless device of the receiving party. The wireless device of the sending party sends the information to be sent in an energy keying pulse sequence within a specific periodic time interval via the wireless device information sending apparatus, and the wireless device of the receiving party obtains the information by monitoring and identifying the energy keying pulse sequence within the specific periodic time interval via the wireless device information receiving apparatus.

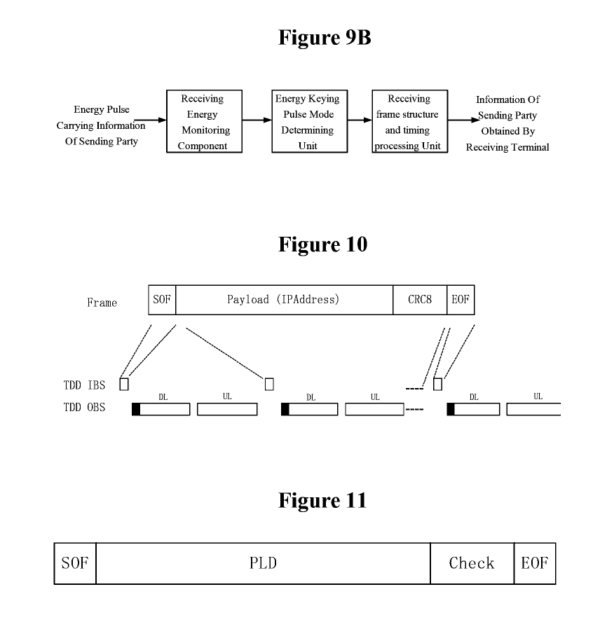

Exemplary structures of the wireless device information sending apparatus and the wireless device information receiving apparatus will be described in conjunction with FIG. 9a and FIG. 9b.

As described above and shown in FIG. 9a, the wireless device information sending apparatus is configured in the wireless device of the sending party, and may include a transmission sequence structure and timing processing unit, an energy keying pulse mode mapping unit and an energy-control sending unit.

The transmission sequence structure and timing processing unit is adapted to perform an energy keying pulse sequence structure adaptation on the information to be sent (such as the IP address information and the sector number information of a base station device). The adaptation determines an energy keying pulse sequence structure which is agreed on by the sending and the receiving parties and required for sending the information, and determines a time for sending the information and outputting a timing control signal to other processing units of the sending party. Specifically, the time interval for sending the energy keying pulse sequence is determined.

The energy keying pulse mode mapping unit is adapted to map an information element to be sent into an energy keying pulse symbol sequence according to the energy keying pulse symbol mapping mode agreed on by the sending and the receiving parties during each symbol duration. In other words, this unit presents the information to be sent in the energy keying pulse symbol sequence for sending the information.

The energy-control sending unit is adapted to send the energy keying pulse sequence carrying the information to be sent according to the corresponding symbol energy keying mode in a determined time (i.e. in the corresponding time interval).

As shown in FIG. 9b, the wireless device information receiving apparatus is configured in the wireless device of the receiving party. Specifically, the wireless device information receiving apparatus may include a receiving energy monitoring unit, an energy keying pulse mode determining unit, a receiving sequence structure and timing processing unit.

The receiving energy monitoring unit is used for monitoring the strength of a received signal at the air interface in real time and providing quantized indication information of the received signal strength, i.e. providing the specific value of the quantized strength of the received signal in real time.

The energy keying pulse mode determining unit is used for determining the indication value of the strength of the received signal within each symbol duration according to a predetermined threshold of the received signal strength with respect to time and obtaining the symbol information sent by the sending party; or, used for determining an indication of the value of the strength of the received signal only according to the threshold of the received signal strength, and obtaining the symbol information sent by the sending party. For example, as shown in FIG. 13, if the energy keying pulse symbol mode defines two kinds of symbols, i.e. binary symbol 0 and 1, the receiver uses a determination threshold for received signal strength verdict. When the received signal strength exceeds the determination threshold, it is determined that the received symbol is 1; otherwise, it is determined that the received symbol is 0.

The transmission sequence structure and timing processing unit is used for outputting a timing control signal of the receiving party according to the predetermined periodic time interval, and collecting a complete information according to the agreed Start Of Sequence bit and End Of Sequence, i.e. obtaining a complete packet sent by the sending party and extracting the information values sent by the sending party, such as the IP address and the sector number, from the packet.

The method of the present invention is now illustrated in conjunction with the drawings.

First of all, the following processing needs to be performed on the wireless device of the sending party.

### 1. Transmission Sequence Structure and Timing Processing

The wireless device of the sending party performs the sequence structure adaptation on the information to be sent (such as the IP address information). In other words, it performs the processing for adding Start Of Sequence and End Of Sequence, checking information and adding verification information. Moreover, the information to be sent is processed according to timing requirements. The information to be sent includes, but is not limited to, the IP address and the sector number information of the wireless device and so on.

FIG. 10 shows an example of the sequence structure and timing in TDD.

In FIG. 10, the physical frame structure of a normal working state includes two parts, i.e. Downlink (DL) and Uplink (UL). There is an idle time interval between the two parts, and the idle time acts as a transmit-receive transition gap of the device.

In the present invention, a newly started base station may use a time interval defined periodically before the time position, to send an energy keying pulse carrying the information to be sent. However, the periodicity rule of the time interval needs to be known to both of the wireless devices of the sending and the receiving parties, for example, via protocol specifications.

A sequence structure may be formed by collecting the time intervals, and is similar to the time slot conception for a narrowband switch. However, the above sequence structure, i.e. the structure of the energy keying pulse sequence, is relatively short, and an apparent sequence delimitation and an error detection capability are required. For example, X.25 frame structure or even a simpler frame structure may be employed.

In FIG. 11, the structure of the energy keying pulse sequence includes Start Of Sequence, Payload, Cyclic Redundancy Check (CRC) and End Of Sequence. FIG. 11 only shows a simple example, and the practical application of the present invention is not limited thereto.

For example, for carrying the 32-bit address of IPv4, a structure of Start Of Sequence+32-bit IP address+8-bit CRC code+End Of Sequence may be used. Information contained in the packet is carried in segments in several predetermined timing slots; in other words, an object sequence structure is generated by performing a structure processing on the information to be carried for sending, and the information is carried in the object time interval via the transmission timing processing.

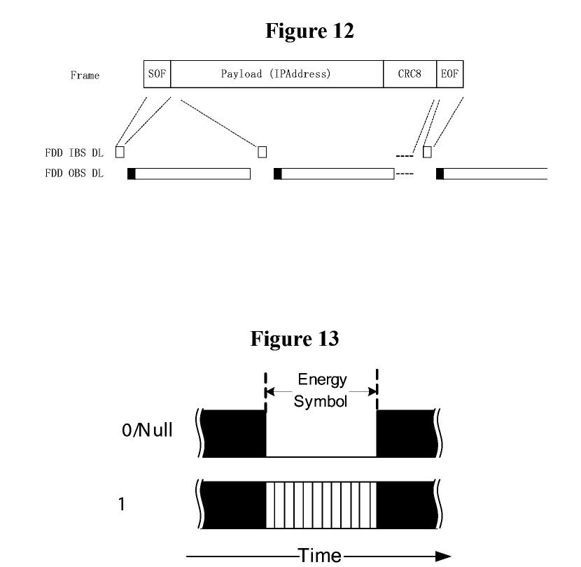

When the FDD mode is employed, the transmission sequence structure and timing processing, as shown in FIG. 12, is similar to the transmission sequence structure and timing processing in the TDD, except that the FDD device does not have a transmit-receive transition gap. Instead, a specific time period before the preamble is defined as the time interval. Because the starting of the downlink physical frame takes the preamble as a flag, the specific time before the preamble may be defined periodically as the time interval, as shown in FIG. 12.

### 2. Processing for Mapping Energy Keying Pulse Mode

To make the sending and the receiving parties have a common symbol definition to transfer the information correctly, a set of symbol mapping modes need to be defined.

The present invention will be illustrated by the following definition modes.

Mode 1: The whole sequence includes symbols 0 and 1. A set of relatively complex sequence delimitation mechanisms is needed. Specifically, similar to X.25, the Start Of Sequence and End Of Sequence, such as 01111110, may be defined and sent, processing adding five ones and a zero after a zero and a one, before the payload part is sent, and performing processing deleting the one and zero after a leading zero and five consecutive ones when the payload part is received. In this mode, only two kinds of symbols, 0 and 1, need to be defined. Therefore, only two sending energy values may be defined, such as High (H)/Low (L), corresponding to 0 and 1 respectively. For example, 1 represents the high energy symbol and 0 represents the low energy symbol i.e. (H-1, L-0). Or, several different energy levels may be defined. For example, four energy values corresponding to codes 00/01/10/11 respectively may be defined, such as 0-00, 1-01, 2-10 and 3-11. More information may be carried in a unit time. For example, when two energy levels are defined, the energy keying pulse mode for sending is shown in FIG. 13.

Mode 2: If special symbols are defined for the sequence delimitation symbol, the time occupation of the whole sequence may be shortened and no additional sequence processing needs to be added. For example, if IP address 129.0.127.200 (1000, 0001 0000, 0000 0111, 1111 1100, 1000) needs to be send, then 0111, 1110+1000, 0001 0000, 0000 0111, 11(0)11 1100, 1000+CRC8+0111, 1110 need to be sent for sending this sequence when the sequence delimitation mode of X.25 is used. If specific sequence delimitation flags are used, the sequence may be defined by a single symbol, and the time used may be saved. The sequence may become <Start Of Sequence>+1000, 0001 0000, 0000 0111, 1111 1100, 1000+CRC8+<End Of Sequence>.

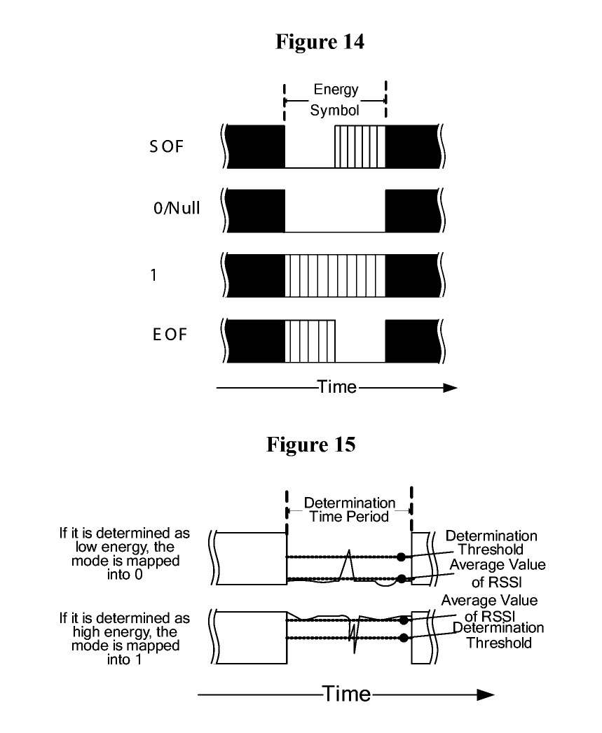

The sequence delimitation flag of the single symbol is now defined in the following example. Specifically, as shown in FIG. 14, the time width of an energy keying pulse symbol is divided into a front part and a back part. A symbol, whose front part and back part are of low/high energy values respectively, is defined as <Start Of Sequence>. A symbol, whose front part and back part are of high/low energy values respectively, is defined as <End Of Sequence>. A symbol, whose front part and back part are both of high energy values, is defined as a binary 1. A symbol, whose front part and back part are both of low energy values, is defined as a binary 0. If the low energy value represents not sending, the binary 0 equals to Null.

Mode 3: A more complex mode is defined, such as a plurality of signal strength levels, mapping multi-bit binary numerical values and more symbol time partition. For example, the time width of the energy keying pulse symbol may be divided in to a plurality of parts, and more information contents are defined for mapping the information to be sent.

### 3. Processing for Sending Energy Control

Specifically, sending energy in the specific time period is controlled. In other words, when a specific energy symbol carrying the information is to be sent, the energy value for sending the information to the air interface is configured dynamically and in real time according to the time interval information and the combination of the high and low values of the sending energy determined in above processing 1, so that the signal may be sent in a determined energy keying mode, and the energy keying pulse carrying the information may be sent from the sending party.

The sending energies of the high level, the low level and different levels in the keying energy value should be obviously different. It is suggested that the difference between energy values in a mode set is greater than 5 DBs. For example, there are only two energy keying values. For the purpose of determining the energy of the signal received at the receiving party, it is suggested that the high energy part is sent at the maximum sending energy of the sending device (usually greater than 20 dbm), while the low energy part is sent at 0 energy or low energy (0 dbm or bellow). When a base station broadcasts to subordinate terminals of an adjacent station, the base station sends the information to the terminals which need to receive the information and are interfered. Therefore, it is convenient for the terminals to extract and determine the information.

After the sending party sends the information with small amount of data, on the receiving party, the wireless device needs to monitor the received signal strength at the air interface, and resolve the information value sent by the wireless device of the sending party according to the strength of signals received in different timing slots and the threshold of the received signal strength with respect to the determination time. The predetermined threshold of the received signal strength with respect to the determination time is determined according to the strength range of signals received by the receiving party in a specific time interval. In other words, the following processing also needs to be performed on the wireless device of the receiving party, so that corresponding information may be received.

### 4. Processing for Monitoring the Received Energy

The received signal strength (RSS) at the air interface is monitored in real time, and a quantized Received Signal Strength Indication (RSSI) is provided.

### 5. Processing for Determining Energy Keying Pulse (Energy Pulse) Mode

During this processing, different modes need to be employed for different definition modes of the sending process. A detailed description is as follows.

(1) If one time period (i.e. the energy keying pulse sequence consists of symbols 0 and 1) is defined in the symbol, the signal strength only needs to be determined in the time period of the symbol duration according to the configured threshold of the received signal strength. For example, when there are only two kinds of energy information, it is assumed that 0 energy is set by the sending party at low sending energy. Specifically, the RSSI characteristic value, at which the energy keying pulse carrying the information is not received at a normal time, is recorded in a specific time period (i.e. the time width of an energy keying pulse symbol) as the characteristic value of the low sending energy. When the RSSI changes greatly in a time period, a new RSSI characteristic value will be recorded as the characteristic value of the high energy, and the determination threshold will be computed. Subsequently, in each corresponding symbol time, the RSSIs monitored within the symbol time length are averaged, the average value is determined with respect to the threshold, and the determination result is mapped into the binary code. For example, high energy symbol corresponds to 1, and low energy symbol corresponds to 0, as shown in FIG. 15.

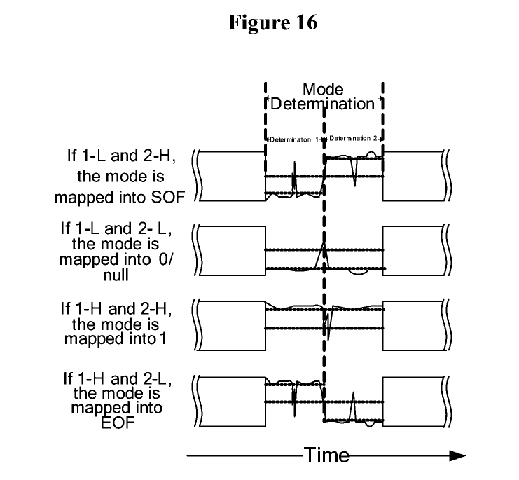

(2) If a symbol is defined for the sequence delimitation, and the time period of the symbol is divided into a front part and a back part, the energy levels (i.e. signal strength) of the two parts of the time period will be first determined in a corresponding time period according to the configured threshold of the received signal strength, then the two determination results are synthesized for a mode determination. The specific determining method is shown in the above description. As shown in FIG. 16, according to the determination result, it may be determined that L/H corresponds to Start Of Sequence, L/L corresponds to 0/null, H/H corresponds to 1 and H/L is defined as End Of Sequence.

(3) According to a combination of various signal strengths, multi-bit binary codes and multi-time period symbols, a receiving and determining function of a relatively complex mode may be simply evolved from a mode similar to the above modes 1 and 2.

### 6. Processing for Sequence Structure and Timing

Specifically, the sequence data is collected and cached according to the determination result of the receiving mode, the timing control of the specified periodic time interval and sequence structure. First of all, a complete packet is collected according to sequence delimitations Start Of Sequence and End Of Sequence, and a correctness check is performed on the content of the packet via redundant check information. If the content is correct, the effective information part in the load (i.e. payload) is extracted. Therefore, the actual information sent by the sending party, such as the IP address and the sector number of the sending party, may be obtained.

The information of the sending party may be effectively sent to the receiving party in an energy keying pulse symbol sequence via the above processings 1 to 6, so that the transfer of information with small amount of data between wireless devices is implemented.

All the wireless receiving devices in the present field have the RSSI monitoring function no matter what modulation-demodulation technology is employed. Therefore, in the present invention, a device, no matter what modulation technology is employed, may send information with small amount of data to other devices in the coverage area via an energy keying pulse symbol by using time periods (i.e. time intervals), and the information may be received correctly. According to the present invention, the implementation of the solution is simplified without increasing the cost and complexity.

In conclusion, according to the present invention, intercommunication of information with small amount of data may be implemented between devices using heterogeneous modulation technology. Moreover, the device according to the present invention has the advantages, such as a high compatibility, a simple implementation and a low cost.

According to the present invention, when a time before the transmit-receive transition gap of a TDD frame structure or a time before the starting position of an FDD frame is used as the time interval, it may be avoided that the original physical burst is interrupted for adding the time period. If the physical burst is interrupted, the corresponding preamble should be added, and unnecessary overhead is added. Therefore, according to the present invention, unnecessary overhead may be avoided.

Additional advantages and modifications will readily occur to those skilled in the art. Therefore, the present invention in its broader aspects is not limited to the specific details and representative embodiments shown and described herein. Accordingly, various modifications and variations may be made without departing from the spirit or scope of the present invention as defined by the appended claims and their equivalents. It is within the scope of the present invention to include all foreseeable equivalents to the elements and structures as described with reference to FIGS. 9-16.

1. A method for implementing information transfer between wireless devices, comprising:
sending, by a wireless device of a sending party, information to be sent, to a receiving party in an energy keying pulse sequence in a specific periodic time interval.

2. The method according to claim 1, wherein the specific periodic time interval comprises:
a time interval before a transmit-receive transition gap of a Time Division Duplexing, TDD, frame structure; or
a time interval before a starting position of a Frequency Division Duplexing, FDD, frame.

3. The method according to claim 1, wherein the information to be sent comprises:
at least one of address information and sector number information of the wireless device.

4. The method according to claim 1, wherein sending the information to be sent to the receiving party comprises:
performing an energy keying pulse mode mapping on the information to be sent according to the structure of the energy keying pulse sequence, and
sending the energy keying pulse sequence at a determined transmission time interval.

5. The method according to claim 4, wherein sending the information to be sent to the receiving party further comprises:
determining a structure and a sending time of the energy keying pulse sequence.

6. The method according to claim 5, wherein the energy keying pulse sequence comprises at least one of:
a Start Of Sequence, an information payload, an End Of Sequence, checking information, a sequence type and a sequence length.

7. The method according to claim 6, wherein the structure of the energy keying pulse sequence comprises one of:
a combination of symbols 0 and 1 employed by each of a Start Of Sequence and an End of Sequence, the combination of symbols being different from the data information payload; and
an energy symbol, employed by the Start Of Sequence and the End of Sequence, different from the data information payload.

8. The method according to claim 7, wherein the energy symbol comprises a combination of different energy levels on timing interval.

9. The method according to claim 1, further comprising:
obtaining, by a wireless device of the receiving party, the information sent from the wireless device of the sending party by monitoring and identifying the energy keying pulse sequence in the specific periodic time interval.

10. The method according to claim 9, wherein obtaining the information sent from the wireless device of the sending party comprises:
monitoring, by the wireless device of the receiving party, a signal strength at an air interface, and resolving information sent from the wireless device of the sending party according to signal strength received in different time interval and a threshold of the received signal strength with respect to a time interval.

11. The method according to claim 10, wherein:
determining the threshold of the received signal strength with respect to the time interval according to a mode of an energy keying pulse symbol sent by the sending party, and
determining each threshold according to a strength range of signals received in the specific time interval.

12. The method according to claim 11, wherein obtaining the information sent from the wireless device of the sending party comprises:
determining to receive complete sequence according to the Start Of sequence and the End of sequence of the energy keying pulse sequence, within combinations of periodic time interval and
obtaining the information sent by the sending party from the complete sequence

13. The method according to claim 12, wherein obtaining the information sent from the wireless device of the sending party further comprises:
checking the information resolved from the complete information; if a checking result of the information is correct, obtaining the information from the payload sent by the sending party.

14. The method according to claim 1, wherein a device between the wireless device of the sending party and the wireless device of the receiving party comprises at least one of:
a device employing a heterogeneous physical layer technology, a device without a symbol-level synchronization, and a device whose frequency bands are not aligned but have an overlapped part.

15. A wireless device, comprising
a wireless device information sending apparatus, adapted to send information to be sent, in an energy keying pulse sequence in a specific periodic time interval.

16. The wireless device according to claim 15, wherein the wireless device information sending apparatus comprises
an energy control sending unit, adapted to send the energy keying pulse symbol sequence carrying information to be sent with an energy corresponding to the energy keying pulse mode at a determined time.

17. The wireless device according to claim 16, wherein the wireless device information sending apparatus further comprises:
a transmission sequence structure and timing processing unit, adapted to perform an energy keying pulse sequence structure adaptation on information to be sent, and to determine a time when to send the information.

18. The wireless device according to claim 17, wherein the wireless device information sending apparatus further comprises
an energy keying pulse mode mapping unit, adapted to map the information to be sent into an energy keying pulse symbol sequence according to a predetermined energy keying pulse mode.

19. A wireless device, comprising
a wireless device information receiving apparatus, adapted to obtain information by monitoring and identifying an energy keying pulse sequence in a specific periodic time interval.

20. The wireless device according to claim 19, wherein the wireless device information receiving apparatus comprises:
an energy keying pulse mode determining unit, adapted to judge indication information of an received signal strength according to a threshold of the received signal strength and optionally according to a determination time corresponding to the strength threshold, and obtain symbol information sent by the sending party.

21. The wireless device according to claim 20, wherein the wireless device information receiving apparatus further comprises:
a receiving sequence structure and timing processing unit, adapted to collect complete sequence information according to a predetermined timing of a time interval, a Start Of Sequence and an End Of Sequence, and extract information data carried in the sequence from the sending party.

22. The wireless device according to claim 21, wherein the wireless device information receiving apparatus further comprises
an energy detection receiving unit, adapted to monitor the received signal strength at an air interface, and determine quantized indication information of the received signal strength.

23. A wireless communication system, comprising a wireless device of a sending party and a wireless device of a receiving party,
wherein a wireless device information sending apparatus is configured in the wireless device of the sending party, and a wireless device information receiving apparatus is configured in the wireless device of the receiving party,
wherein the wireless device of the sending party is adapted to send information to be sent in an energy keying pulse sequence in a specific periodic time interval via the wireless device information sending apparatus, and
wherein the wireless device of the receiving party is adapted to obtain the information by monitoring and identifying the energy keying pulse sequence in the specific periodic time interval via the wireless device information receiving apparatus.
